(19) United States
(12) Patent Application Publication
(10) Pub. No.: US 2009/0157949 A1
(43) Pub. Date: Jun. 18, 2009

(54) ADDRESS TRANSLATION BETWEEN A MEMORY CONTROLLER AND AN EXTERNAL MEMORY DEVICE

(76) Inventor: Robert N. Leibowitz, Boise, ID (US)

Correspondence Address: Attn: Kenneth W. Bolvin;LEFFERT JAY & POLGLAZE, P.A., P. O. Box 581009, Minneapolis, MN, 55458-1009, US

(21) Appl. No.: 11/958,514

(22) Filed: Dec. 18, 2007

(51) Int. Cl. G06F 12/08; G06F 12/02

(52) U.S. Cl. 711/103; 711/206; 711/E12.008; 711/E12.058

(57) ABSTRACT

In one or more embodiments, address translation is performed over a dedicated serial bus between a non-volatile memory controller and a memory device that is external from the non-volatile memory device. The memory controller accesses memory address translation data in the external memory device to determine a physical address that corresponds to a logical memory address. The controller can then use the physical memory address to generate memory signals for the non-volatile memory array.

### TECHNICAL FIELD OF THE INVENTION

The present invention relates generally to memory devices and in particular the present invention relates to non-volatile memory devices.

### BACKGROUND OF THE INVENTION

Memory devices are typically provided as internal, semiconductor, integrated circuits in computers or other electronic devices. There are many different types of memory including random-access memory (RAM), read only memory (ROM), dynamic random access memory (DRAM), static RAM (SRAM), synchronous dynamic RAM (SDRAM), and flash memory.

Flash memory devices have developed into a popular source of non-volatile memory for a wide range of electronic applications. Flash memory devices typically use a one-transistor memory cell that allows for high memory densities, high reliability, and low power consumption. Common uses for flash memory include personal computers, personal digital assistants (PDAs), digital cameras, and cellular telephones. Program code and system data such as a basic input/output system (BIOS) are typically stored in flash memory devices for use in personal computer systems.

The memory controllers of flash memory devices typically use large blocks of embedded static RAM to store physical to/from translation tables that map between logical and physical address spaces. These tables can be used for accessing redundant memory columns when a logical address is received that would access a physical address of a defective memory column. As the density of the flash memory array is increased, the size of the embedded SRAM also has to increase as well. This requires an increase in the valuable real estate required for the static RAM that reduces the amount of room available for the flash memory array and its support circuitry.

One way around this problem is to use parts of the flash memory array to store these tables. However, not only does this reduce the amount of memory available to the end user for data storage, performance of the memory device suffers as well. Since programming/reading flash memory requires more time than SRAM, the time required for the controller to store and retrieve table data from a flash memory array is considerably longer than with SRAM.

For the reasons stated above, and for other reasons stated below that will become apparent to those skilled in the art upon reading and understanding the present specification, there is a need in the art to decrease the amount of integrated circuit real estate required for address translation without affecting system performance.

### BRIEF DESCRIPTION OF THE DRAWINGS

FIG. 1 shows block diagram of one embodiment for an address translation system incorporating an external memory device.

FIG. 2 shows a flowchart of one embodiment of an address translation method in accordance with the system of FIG. 1.

FIG. 3 shows a block diagram of one embodiment of a memory system that can incorporate the address translation embodiments of the present disclosure.

### DETAILED DESCRIPTION

In the following detailed description of the invention, reference is made to the accompanying drawings that form a part hereof and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. The following detailed description is, therefore, not to be taken in a limiting sense, and the scope of the present invention is defined only by the appended claims and equivalents thereof.

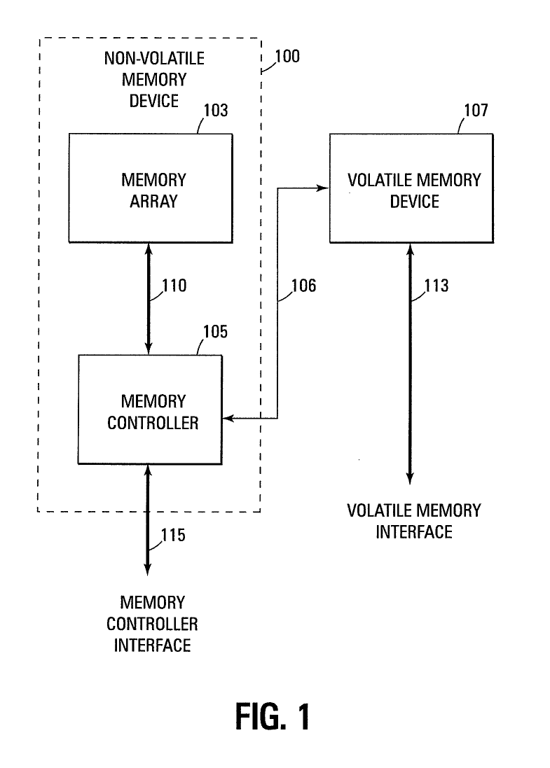

FIG. 1 illustrates a block diagram of one embodiment of an address translation system incorporating an external memory device. The system is comprised of a non-volatile memory device 100 and a DRAM 107 that is separate from the non-volatile memory die.

In one embodiment, the non-volatile memory device is a NAND flash memory. Alternate embodiments can use other types of flash memory such as NOR or AND. Alternate embodiments can also use other types of non-volatile memory devices.

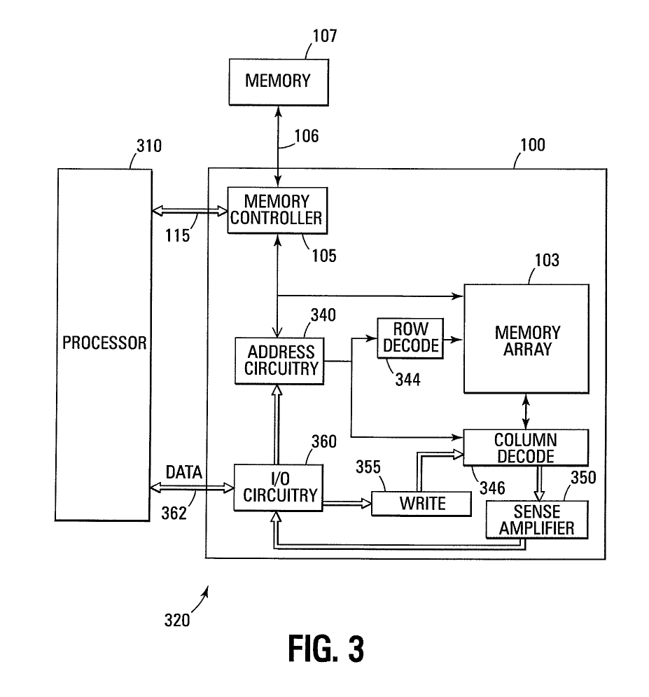

Only portions of the non-volatile memory device 100 that are relevant to the present description are shown in FIG. 1. A more detailed description of a non-volatile memory device are shown and discussed with reference to FIG. 3.

The non-volatile memory device 100 is comprised of a memory array 103 that communicates with a memory controller 105 over a bus 110. The memory controller 105 can send program, read, and erase commands over the bus 110 to the memory array 103. For example, the controller 105 can use the bus 110 to control program voltages, read voltages, and erase voltages that are applied to the word lines and bit lines of the memory array 103 during their respective operations. The controller 110 can communicate with the memory array 103 using either digital signals or analog signals.

The memory controller 105 communicates with external controllers, such as microprocessors, over a control bus 115. The control bus 115 can be a standard NAND controller interface such as SATA, SecureDigital (SD) format, and MultiMediaCard (MMC) format. Other memory interfaces can also be used.

The memory controller 105 is also coupled to an external memory device 107 in which the address mapping tables for the address translation method are stored. The external memory device 107, in one embodiment, is a DRAM. Alternate embodiments can use other forms of memory for storing the address mapping tables. The memory device 107 communicates with additional controllers or other devices over a standard memory interface 113 using such formats as a double data rate (DDR) format, a double data rate 2 (DDR2) format, or a low-power synchronous DRAM (LPDRAM) format. Alternate embodiments can use other bus formats for communicating with the memory device. The external memory device can store other data in addition to the address mapping/translation tables such as buffering data from a host processor (DMAing the data from host through the controller to the DRAM), defect management tables for the memory device, as well as system information such as FAT tables.

The memory controller 105 and the external memory device 107 communicate over a serial bus 106. This can be a high speed (e.g., 1 Gb/s) serial bus 106. This bus 106 is used to transfer address translation information (e.g., address mapping tables) back and forth between the external memory device 107 and the non-volatile memory controller 105.

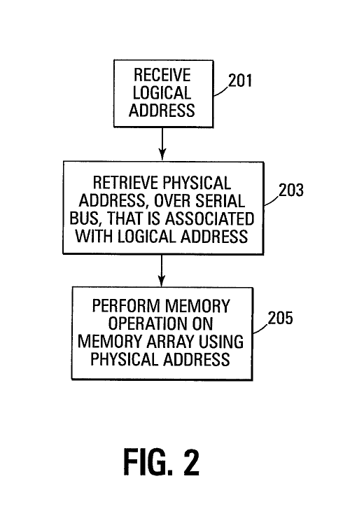

FIG. 2 illustrates a flowchart of one embodiment of a method for address translation communicated between a non-volatile memory device and an external memory device over a high speed serial bus. The memory controller receives a logical memory address 201. The address can be contained in a read command or a program (write) command that is transmitted by an external system. One such memory system is illustrated in FIG. 3 and described subsequently. The logical address may also have been generated by the memory controller itself in the course of performing an internal memory operation such as erasing a block of memory.

Once the memory controller has the logical address, it retrieves the corresponding physical address from the external memory device 203. The physical address is retrieved over the serial bus that couples the memory controller to the external memory device. In one embodiment, the memory controller accesses an address translation table stored in the external memory device. The translation table is comprised of the logical addresses or logical address range assigned to the non-volatile memory device with the corresponding physical addresses or physical address range. Thus, the memory controller finds the physical address in the table that corresponds to the received/generated logical address.

The physical memory address that was retrieved from the external memory over the dedicated serial bus is then used in the desired operation 205. For example, if a read command with a logical address was received, the memory controller uses the retrieved physical memory address to perform the read operation.

The address translation table in the external memory device can also contain the physical addresses of redundant memory columns for the non-volatile memory device. For example, when a memory column of the non-volatile memory array is determined to be defective, it is replaced with a redundant column in another part of the memory array or in a redundant memory array. The address translation table is then updated with the old logical address and new corresponding physical address of the redundant column. This allows all future accesses to the defective column to be forwarded to the new redundant column.

FIG. 3 illustrates a functional block diagram of a memory device 100. The memory device 100 is coupled to an external processor 310. The processor 310 may be a microprocessor or some other type of controlling circuitry. The memory device 100 and the processor 310 form part of a memory system 320. The memory device 100 has been simplified to focus on features of the memory that are helpful in understanding the present invention. The system processor 310 can be part of the same circuit card as the memory device 100 or be completely separate from the memory device 100.

The memory device 100 includes an array 103 of non-volatile memory cells. The memory array 103 is arranged in banks of word line rows and bit line columns. In one embodiment, the columns of the memory array 103 are comprised of series strings of memory cells. As is well known in the art, the connections of the cells to the bit lines determines whether the array is a NAND architecture, an AND architecture, or a NOR architecture.

Address buffer circuitry 340 is provided to latch address signals provided through the I/O circuitry 360. Address signals are received and decoded by a row decoder 344 and a column decoder 346 to access the memory array 330. It will be appreciated by those skilled in the art, with the benefit of the present description, that the number of address input connections depends on the density and architecture of the memory array 103. That is, the number of addresses increases with both increased memory cell counts and increased bank and block counts.

The memory device 100 reads data in the memory array 103 by sensing voltage or current changes in the memory array columns using sense amplifier circuitry 350. The sense amplifier circuitry 350, in one embodiment, is coupled to read and latch a row of data from the memory array 103. Data input and output buffer circuitry 360 is included for bidirectional data communication as well as address communication over a plurality of data connections 362 with the controller 310. Write circuitry 355 is provided to write data to the memory array.

A memory controller 105 decodes signals provided on control connections 115 from the processor 310. These signals are used to control the operations on the memory array 103, including data read, data write (program), and erase operations. The memory controller circuitry 105 may be a state machine, a sequencer, or some other type of controller to generate the memory control signals.

The flash memory device illustrated in FIG. 3 has been simplified to facilitate a basic understanding of the features of the memory. A more detailed understanding of internal circuitry and functions of flash memories are known to those skilled in the art.

### Conclusion

In summary, in an embodiment of the present invention, an external memory device is coupled to a non-volatile memory controller over a dedicated serial bus. The memory controller can then perform address mapping operations with address translation information/data obtained from the external memory device using logical memory addresses. This can be accomplished without using valuable real estate on the non-volatile memory device or memory controller for static memory to store the address translation data. Additionally, the greater speed of a DRAM as the external memory as compared to using portions of the non-volatile memory mean an increase in memory system performance.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

What is claimed is:

1. An address translation system comprising:
a non-volatile memory device comprising a memory controller and a memory array; and
an external memory device, separate from the non-volatile memory device, for storing address translation data accessible by the memory controller over a dedicated serial data bus.

2. The address translation system of claim 1 wherein the address translation data comprises a table comprised of logical memory addresses and their corresponding physical memory addresses in the non-volatile memory device.

3. The address translation system of claim 1 wherein the memory array is comprised of a NAND architecture.

4. The address translation system of claim 1 wherein the external memory device is a DRAM.

5. The address translation system of claim 1 and further comprising a volatile memory interface coupled to the external memory device for enabling access to the external memory device by an external controller.

6. The address translation system of claim 1 and further comprising a memory controller interface coupled to the memory controller for enabling access to the memory controller by an external controller.

7. An address translation system for translating between a logical address and a physical address, the system comprising:
a NAND flash memory device comprising a memory controller coupled to a NAND non-volatile memory array;
an external volatile memory device that is separate from the NAND flash memory device and stores address translation information accessible by the memory controller; and
a dedicated serial data bus connected between the memory controller and the external volatile memory device to enable the memory controller to access the address translation information.

8. The address translation system of claim 7 and further comprising a DRAM interface coupled to the external volatile memory device and a NAND controller interface coupled to the NAND flash memory device.

9. The address translation system of claim 7 wherein the memory controller is adapted to generate a range of logical addresses corresponding to redundant memory columns in the memory array that replace defective memory columns.

10. The address translation system of claim 9 wherein the memory controller is further adapted to access the external volatile memory device over the dedicated serial data bus to retrieve physical memory addresses that correspond to the range of logical addresses corresponding to redundant memory columns.

11. The address translation system of claim 8 wherein the DRAM interface is comprised of one of a double-data rate interface or a low-power synchronous DRAM interface.

12. The address translation system of claim 8 wherein the NAND controller interface is comprised of one of a Secure Digital interface, a MultiMediaCard interface, or a SATA interface.

13. A method for memory address translation comprising:
a non-volatile memory device memory controller accessing with a logical memory address, over a dedicated serial bus, an address translation table in a volatile memory device external from the non-volatile memory device;
the memory controller retrieving a physical memory address, corresponding to the logical memory address, from the translation table; and
the memory controller performing a memory operation on a non-volatile memory array of the non-volatile memory device at least partially in response to the physical memory address.

14. The method of claim 13 and further including receiving the logical address.

15. The method of claim 13 and further including the memory controller generating the logical address in response to defective memory columns.

16. The method of claim 13 wherein the memory operation is received by the memory controller and the memory operation comprises the logical memory address.

17. The method of claim 13 wherein the memory operation comprises one of a read operation comprising a logical read address or a write operation comprising a logical write address.

18. A memory system comprising:
a processor for controlling operation of the memory system and generating memory signals; and
a non-volatile memory device coupled to the processor and operating at least partially in response to the memory signals, the memory device comprising:
a non-volatile memory array coupled to a memory controller, the memory controller coupled to the processor through a memory controller interface; and
a DRAM coupled to the memory controller over a dedicated serial bus that connects only the DRAM and the memory controller, the DRAM comprising data for translating between a logical memory address and a physical memory address.

19. The system of claim 18 wherein the non-volatile memory device is one of a NAND flash memory device or a NOR flash memory device.

20. The system of claim 18 wherein the memory controller is adapted to access the data for translating over the dedicated serial bus in order to map a received logical memory address to a physical memory address in the non-volatile memory array.

21. The system of claim 18 wherein the dedicated serial bus is a high speed bus operating at approximately 1 Gb/s.

22. A method for memory address translation comprising:
a non-volatile memory device memory controller determining logical memory addresses for columns of a memory array that are defective;
the memory controller accessing address mapping data with the logical memory addresses, over a dedicated serial bus, from a volatile memory device external from the non-volatile memory device; and
the memory controller determining, from the address mapping data, physical memory addresses corresponding to the logical memory addresses.

23. The method of claim 22 and further including the memory controller using the physical memory addresses in generating memory control signals.

24. The method of claim 22 wherein the address mapping data comprises a logical memory address range with a corresponding physical address range.

25. The method of claim 22 wherein the columns of the memory array are comprised of NAND series strings of memory cells.
